(19) United States
(12) Patent Application Publication
(10) Pub. No.: US 2026/0336843 A1
(43) Pub. Date: Oct. 29, 2026

(54) SYSTEMS AND METHODS FOR SECURE LANDING OF DELIVERY AIR VEHICLES

(71) Applicant: I R Kinetics Limited, Earby (GB)

(72) Inventor: Andrew Bradley

(21) Appl. No.: 19/122,222

(22) PCT Filed: Oct. 19, 2023
(86) PCT No.: PCT/GB2023/052722

§ 371 Date: Apr. 17, 2025

(30) Foreign Application Priority Data
Oct. 19, 2022 (GB) 2215450.4
Jan. 17, 2023 (GB) 2300681.0

(51) Int. Cl. B64U 70/95; B64U 10/14; B64U 20/80; B64U 70/97; B64U 101/64; G05D 1/248; G05D 1/654; G05D 105/28; G05D 109/25; G08G 5/26; G08G 5/57

(52) U.S. Cl. CPC B64U 70/95; B64U 10/14; B64U 20/80; B64U 70/97; G05D 1/248; G05D 1/654; G08G 5/26; G08G 5/57; B64U 2101/64; B64U 2201/104; G05D 2105/28; G05D 2109/254

(57) ABSTRACT

The present invention concerns a system for positioning an airborne vehicle (502) at a geographic location, the system comprising the airborne vehicle (502) having one or more infra-red (I R) detectors, and a positioning beacon (504) located at the geographic location, the positioning beacon (504) being configured to wirelessly transmit a landing identifier for detection by the airborne vehicle (502) and comprising one or more emitters or reflectors configured to respectively emit or reflect an IR signal, wherein the airborne vehicle (502) is configured to receive the landing identifier and the emitted or reflected IR signal to compare the received landing identifier and a stored unique identifier and if the received landing identifier matches the stored unique identifier to use the emitted or reflected signal to control movement of the airborne vehicle (502) with respect to the positioning beacon,

### FIELD OF THE INVENTION

The present disclosure is concerned with systems and methods for the safe timely and secure landing of delivery drones at their intended locations. More particularly though not exclusively the present disclosure is directed at improvements in or relating to systems and methods for the secure landing of autonomous drones or drones in an autonomous or semi-autonomous landing phase of flight at their intended destinations where they are to collect and/or deliver consignments of goods for individuals or organisations. These improvements ensure that drone deliveries can be made reliably to the vast majority of if not all types of destinations occurring in densely populated city and urban environments as well as more rural or remote locations and to mobile landing sites. Also, the drone delivery journeys may or may not be linked to local, regional, national, or international air traffic management systems. It is to be appreciated that whilst the present disclosure is primarily concerned with the provision of delivery air vehicles, it is also envisaged that the disclosures may be equally applicable to any airborne vehicle for a multitude of purposes.

### BACKGROUND OF THE INVENTION

Ongoing developments and huge investments over several years in delivery drone technology have been driven by a need to take advantage of the new capabilities afforded by autonomous drones to increase delivery speeds, reduce order-to-delivery times, and reduce the cost and environmental footprint of small consignment deliveries to customers. The cost of a drone local delivery is estimated to be 10% of the cost of the same delivery by road. Moving to drone deliveries will accelerate the transition from fossil fuel to electrified transport. Delivery times of better than 5 minutes enable local suppliers to compete more effectively with regional and national suppliers, further reducing transport costs and emissions. From food and drink to phones and medicines the economic and environmental benefits of drones over trucks, lorries, and vans to transit small consignments over short distances are widely recognised.

For such drone deliveries to be completed in a safe secure and timely manner the drone must locate and land at the intended collection site for consignment loading by the supplier and then locate and land at the intended delivery site for consignment off-loading to the customer. Landing is the most hazardous of all normal operational manoeuvres for any airborne vehicle, even when an on-board or remote pilot is in direct control supported by an independent air traffic control service and the landing is at a dedicated airfield, landing runway or landing pad fitted with sophisticated landing aid technologies. In the case of drones delivering to domestic, business, or other customers most of those support technologies and systems are not currently available and several challenges have been encountered for drone design and for autonomous landing including how to cater for the infinite variety of potential landing sites and conditions, how to contend with malicious interference and how to ensure that the identified landing site is the intended one.

Many early trials of drone delivery services had the drone controlled by a remote pilot with the support of on-board sensors such as a downward facing video camera linked back in real time to the remote pilot. The anticipated scale of demand for drone deliveries of light consignments makes this option extremely manpower intensive and hence expensive. There are also technical difficulties in maintaining secure communication and control links between the drone and the remote pilot over realistic journey ranges. This has led research and development to focus on autonomous drones, pre-programmed or programmed in flight with collection and delivery locations and equipped with lightweight navigation systems including global positioning systems GPS and inertial navigation systems INS.

This approach can provide reliable autonomous flying in low-level airspace (below 400 ft is the normal space for drone operations) to and from the locations of the collection and delivery sites in areas where GPS performance is reliable. However, in the majority of built up, particularly high-rise, urban and city environments GPS is known to be unreliable, suffering from occlusion of satellite lines-of-sight, multi-path reflections, etc. and even when supplemented with INS the achievable navigation and positioning accuracies are such that they can only get the drone to an approximate location within which there may be several potential delivery locations or addresses and at busy times two or more of them may be have ordered a consignment to be delivered.

In addition, even in locations where it works, the use of GPS/INS alone for positioning and navigation does not address the challenges of identifying the correct landing site with a high degree of confidence and ensuring safe and secure landing in the very precise locations that delivery customers typically have at their disposal. GPS/INS positioning and navigation accuracies and reliabilities are insufficient to provide the precision required for safe drone delivery landing. Recent developments have therefore tended to service more rural locations containing customers with relatively large and secure private gardens or areas of land.

The approaches to landing the consignment have converged around two alternative strategies at the delivery site. Firstly, completing the landing of the drone at the site prior to the automatic or manual release of the consignment and secondly, equipping the drone with a mechanism for lowering the consignment on a cable as the drone hovers above and then releasing the consignment once it has been landed on the delivery site. The hovering strategy takes more power from the drone batteries. At the collection site either strategy may be adopted so that the consignment can be received on board.

In all of the prior art identified, these automated delivery strategies rely on the drone being fitted with several sensors that automatically survey the potentially infinite variety of landing sites for hazards (people, animals, water, overhead cables, obstructions, . . . ), those sensors being derived from a range of technologies including RADAR (Radio Detection And Ranging), LIDAR (Light Imaging, Detection & Ranging), and EO (Electro-Optic), all of which have reduced in mass, size, power consumption, heat output and susceptibility to environmental hazards such as mechanical shock, vibration and electromagnetic interference to the extent that they can be integrated onto the drone to work in combination to provide some situational awareness at the delivery site. However, the complexity of all such approaches to situational awareness based on multiple sensors potentially supported by artificial intelligence, machine learning and sensor fusion in the safety critical application of drone landing is considerable. This complexity inevitably drives up vehicle weight and cost and hence the practicality of the approach and cannot be relied upon to reduce safety hazard risks to acceptable levels.

The potential variety of locations, circumstances, conditions, and threats that the drone may encounter at and around the landing site has rendered the delivery landing challenge for the mass market intractable to date. Typically, the drone flight path based on GPS/INS navigation is informed and supplemented by pre-flight information on static hazards such as masts, buildings, power lines, trees, etc. However, once the drone has reached the vicinity of the GPS/INS approximate latitude and longitude co-ordinates of the landing site the reliability and accuracy of the navigation can significantly degrade as the drone descends into the urban environment such that the precision of any pre-flight information becomes irrelevant. In addition, even if successful in mitigating the challenge of local and possibly temporary hazard identification such as the presence of children, pets or wildlife, these technologies would not solve the problem of uniquely identifying the intended landing site from amongst several candidates.

If drone commercial deliveries are to be enabled to most of the population of private and business customers then deliveries to landing sites within urban and city environments must be convenient, practical, safe, and secure. Typical landing sites at ground level are private land including small gardens, yards, driveways, enclosures, etc. Landing sites above ground level include private balconies and rooftops. There may also be shared or communal locations at ground level or on buildings. Many of these sites are small, have restricted access from above and are constrained by surrounding structures. Based on typical dimensions of domestic back yards, balconies, etc. a delivery drone must be able to land precisely within a square of one meter side, either vertically from above or, in the case of a balcony, following a tight horizontal to vertical manoeuvre immediately above the landing area. None of this is possible with the positioning and navigating inaccuracies of known technologies such as GPS/INS, augmented GPS or other systems [Ref 1]. Furthermore, deliveries need to be made in daylight or in darkness and in fair weather or foul. The landing sites must be free of foreign objects at the time of landing, including people and animals, and the systems and methods must support clear legal responsibilities of the involved parties. Finally, landed consignments need to be collected by the intended recipient and not susceptible to theft or malicious interference. Theft is also a risk for the drone. In summary the drone must be able to land the consignment safely and securely with an acceptably low risk of damage to people, animals, property, and itself.

Despite the huge investments made by several technology companies in commercial delivery drones the past decade has shown slow progress, with few regulatory approvals achieved. The limited inroads that have been made have been with cable landing drones, supplemented by remote pilot support and only in more rural and open locations. The challenge of addressing the mass market for light consignment deliveries has not been met.

It is an object of the present invention to overcome one or more of the problems described above.

### SUMMARY OF THE INVENTION

According to a first aspect of the present embodiments, there is provided a system for positioning an airborne vehicle at a geographic location. The system comprises the airborne vehicle having one or more infra-red (IR) detectors and a positioning beacon located at the geographic location. The positioning beacon is configured to wirelessly transmit a landing identifier for detection by the airborne vehicle and comprises one or more emitters or reflectors configured to respectively emit or reflect an IR signal. The airborne vehicle is configured to receive the landing identifier and the emitted or reflected IR signal, to compare the received landing identifier and a stored unique identifier, and if the received landing identifier matches the stored unique identifier to use the emitted or reflected signal, to control movement of the airborne vehicle with respect to the positioning beacon.

In some embodiments, the movement of the airborne vehicle is controlled in accordance with stored positioning data comprising data indicating an intended position of the airborne vehicle relative to the IR radiation being emitted from or reflected by the one or more emitters or reflectors of the positioning beacon. In such embodiments, the airborne vehicle may further comprise a consignment holding system configured to enable the airborne vehicle to carry a load, and wherein the airborne vehicle is configured to operate the consignment holding system to accept or release a load when at the intended position.

In some relevant embodiments, the airborne vehicle further comprises a GPS navigation system, and wherein the airborne vehicle is further configured to use stored GPS coordinates indicating an approximate position of the geographic location to control movement of the airborne vehicle toward the approximate position of the geographic location.

In some embodiments, the airborne vehicle further comprises a GPS navigation system, and wherein the airborne vehicle is further configured to use stored GPS coordinates indicating an approximate position of the geographic location to control movement of the airborne vehicle toward the approximate position of the geographic location, and the system further comprises a second positioning beacon at a second geographic location, the second positioning beacon being configured to wirelessly transmit the landing identifier for detection by the airborne vehicle and comprises a second one or more emitters or reflectors configured to respectively emit or reflect an IR signal. In these embodiments, the airborne vehicle is further configured to use stored GPS coordinates indicating an approximate position of the second geographic location to control movement of the airborne vehicle toward the approximate position of the second geographic location, and wherein the movement of the airborne vehicle is controlled in accordance with stored positioning data comprising data indicating a first and a second intended position of the airborne vehicle relative to the IR radiation being emitted from or reflected by the one or more emitters or reflectors of the positioning beacon and the second one or more emitters or reflectors of the positioning beacon respectively. The airborne vehicle further comprises a consignment holding system configured to enable the airborne vehicle to carry a load, and wherein the airborne vehicle is configured to operate the consignment holding system to accept a load when at the first intended position and to release the load at the second intended position.

In further embodiments, the one or more emitters or reflectors comprises one or more emitters, and the positioning beacon is further configured to transmit the landing identifier for detection by the airborne vehicle by appropriately modulating the IR radiation being emitted from at least one of the one or more emitters.

In yet further embodiments, the one or more emitters or reflectors comprises one or more emitters, the one or more IR detectors are configured to activate when at the geographic location, and the one or more emitters are configured to activate for a portion of the time that the one or more IR detectors are activated.

In some embodiments, the one or more emitters or reflectors comprises one or more reflectors, wherein at least one of the one or more reflectors comprises a QR code or a bar code or other pattern comprising the landing identifier, and transmission of the landing identifier comprises a reflected signal from the one or more reflectors received by the one or more IR detectors being recognised by the airborne vehicle. In such embodiments, the airborne vehicle may further comprise one or more emitters configured to direct IR radiation toward the one or more reflectors of the positioning beacon. Where the airborne vehicle comprises such emitters, the one or more emitters of the airborne vehicle may be configured to activate when at the geographic location. Further, where the airborne vehicle comprises such emitters, the one or more IR detectors may be configured to activate when at the geographic location, and the one or more emitters of the airborne vehicle may be configured to activate for a portion of the time that the one or more IR detectors are activated.

In further relevant embodiments, the one or more emitters or reflectors are configured to respectively emit or reflect near infra-red, NIR, radiation.

In some embodiments, the one or more emitters or reflectors are configured to respectively emit or reflect narrowband NIR.

In further embodiments, the airborne vehicle or the positioning beacon, comprises a receiver, and the airborne vehicle or the positioning beacon is configured to receive the unique identification data to be stored in a respective data store from an external communications network via the receiver.

In some relevant embodiments, the airborne vehicle or the positioning beacon comprises a data input device, and the airborne vehicle or the positioning beacon is configured to receive the unique identification data to be stored in a respective data store from information input via the input device.

In further relevant embodiments, the airborne vehicle is configured to land in a landing area, the location of the landing area being defined by the detected emitted or reflected signal. In such embodiments, the positioning beacon may comprise at least two emitters or reflectors, and the at least two emitters or reflectors are arranged with respect to one another and the landing area in a known geometric formation. If this is the case, the positioning beacon may comprise three emitters or reflectors arranged in an L-shape.

In some embodiments, the airborne vehicle is configured to land in a landing area, the location of the landing area being defined by the detected emitted or reflected signal, wherein the positioning beacon comprises at least two emitters or reflectors, and the at least two emitters or reflectors are arranged with respect to one another and the landing area in a known geometric formation and the positioning beacon comprises three or more emitters or reflectors and the positioning beacon is located on a moving surface.

In further embodiments, the one or more emitters or reflectors are configured to emit or reflect IR radiation substantially vertically.

In some embodiments, the positioning beacon comprises one or more emitters, and the one or more emitters are configured to emit IR radiation in accordance with an indicated time interval stored in the positioning beacon.

In certain embodiments, the one or more IR detectors operate at a frequency of between 25 Hz and 200 Hz. In such cases, the one or more IR detectors may operate at a frequency of 60 Hz.

In further embodiments, the positioning beacon comprises a mobile telecommunications device, such as a smartphone.

In embodiments of this aspect, the one or more emitters or reflectors are configured to be attached to a mobile telecommunications device, such as a smartphone.

In some embodiments, the positioning beacon further comprises a transmitter configured to transmit the landing identifier.

In further embodiments of this aspect, the airborne vehicle comprises at least one or more IR detectors, wherein the IR detectors are arranged with complementary fields of view, and the positioning beacon comprises at least four emitters or reflectors arranged in pairs, with at least one pair being arranged to emit or reflect IR signals in each of the complementary fields of view.

In a further aspect of the present embodiments, there is provided an airborne vehicle configured to be positioned at a geographic location. The airborne vehicle comprises one or more infra-red (IR) detectors for receiving an IR signal emitted or reflected from a positioning beacon provided at the geographic location. The airborne vehicle is configured to receive a landing identifier wirelessly transmitted to the airborne vehicle by the positioning beacon, compare the received landing identifier and a stored unique identifier, and if the received landing identifier matches the stored unique identifier, use the emitted or reflected signal to control movement of the airborne vehicle towards the positioning beacon. It is to be appreciated that where applicable, this aspect of the invention may be combined with any of the modifications described above with respect to the first aspect of the invention.

In a yet further aspect of the present embodiments, there is provided a positioning beacon for positioning an airborne vehicle according to previous aspects. The positioning beacon comprises one or more infra-red (IR) emitters or reflectors configured to respectively emit or reflect an IR signal for use in controlling movement of the airborne vehicle towards the positioning beacon, and a generator for generating a signal including a landing identifier of the positioning beacon. The positioning beacon is configured to a wirelessly transmit the signal including the landing identifier for unique detection of the positioning beacon by the airborne vehicle. It is to be appreciated that where applicable, this aspect of the invention may be combined with any of the modifications described above with respect to the previous aspects of the invention.

In another aspect of the present embodiments, there is provided a method for positioning an airborne vehicle at a geographic location. The method comprises wirelessly transmitting, from a positioning beacon at the geographic location, a landing identifier for detection by the airborne vehicle, receiving an emitted or reflected infra-red, IR, signal from the positioning beacon at one or more IR detectors of the airborne vehicle, receiving, at the airborne vehicle, the landing identifier, comparing the landing identifier with a stored unique identifier, and where the landing identifier and stored unique identifier match, use the emitter or reflected signal to control movement of the airborne vehicle with respect to the positioning beacon. It is to be appreciated that where applicable, this aspect of the invention may be combined with any of the modifications described above with respect to the previous aspects of the invention.

In some embodiments of this aspect, the method further comprises wirelessly transmitting, from a second positioning beacon at a second geographic location, the landing identifier for detection by the airborne vehicle, controlling movement of the airborne vehicle using a GPS navigation system to move toward an approximate position of the geographic location using first stored GPS coordinates, when at the approximate position of the geographic location, controlling movement of the airborne vehicle in accordance with stored positioning data comprising data indicating a first intended position of the airborne vehicle relative to the received IR radiation from the positioning beacon, accepting a load into a consignment holding system of the airborne vehicle when at the first intended position, once the load is accepted, controlling movement of the airborne vehicle using the GPS navigation system to move toward an approximate position of the second geographic location using second stored GPS coordinates, when at the approximate position of the second geographic location, receiving an emitted or reflected IR signal from the second positioning beacon at the one or more IR detectors of the airborne vehicle, controlling movement of the airborne vehicle in accordance with stored positioning data comprising data indicating a second intended position of the airborne vehicle relative to the IR radiation being emitted from or reflected by the second positioning beacon, and releasing the load from the consignment holding system of the airborne vehicle when at the second intended position.

### BRIEF DESCRIPTION OF THE DRAWINGS

In order that the disclosure may be more readily understood, reference will now be made, by way of example, to the accompanying drawings in which:

FIG. 1 is an isometric and schematic view of present embodiments illustrating the whole drone landing system in a use scenario;

FIG. 2 is an isometric, schematic and a system view of present embodiments illustrating a landing beacon of FIG. 1 in a use scenario;

FIG. 3 is an isometric, schematic and a system view of present embodiments illustrating the drone of FIG. 1 in a use scenario;

FIG. 4 is an isometric view of present embodiments illustrating the drone and landing beacon in an alternate use scenario;

FIG. 5 is an isometric view of present embodiments illustrating the drone and landing beacon in a further alternate use scenario;

FIG. 6 is a flow diagram of present embodiments illustrating a method of operation of the drone landing system of FIGS. 1 to 3;

FIG. 7 is a schematic and system view of present embodiments illustrating a general use scenario of an airborne vehicle and positioning beacon system;

FIG. 8 is a schematic and system view of present embodiments illustrating an airborne vehicle of the scenario of FIG. 7;

FIG. 9 is a schematic and system view of present embodiments illustrating a positioning beacon of the scenario of FIG. 7; and

FIG. 10 is a flow diagram of present embodiments illustrating a method of operation of the system of FIG. 7.

### DETAILED DESCRIPTION

It is a feature of the present disclosure that the approach taken by the majority of identified prior art to focus on the onboard system technology to meet the challenge is overturned and that a wider system of interest view is taken to provide systems and methods embodying in close combination the dual functions of both uniquely identifying a landing site and precisely landing the drone at the site.

Embodiments described herein encompass simplified on-board drone technology in combination with key functions within a smart and agile infrastructure which combine overall to reach a whole system solution to the challenge. These embodiments employ the same specific sensor type described in international application WO2022/003343 (the contents of which are incorporated herein by reference), namely infrared (IR) and in some embodiments, more specifically near infrared (NIR) technology, that delivers precise drone kinematic self-localisation and self-tracking to enable highly accurate drone landing in daylight or at night and with significant tolerance to adverse weather conditions. It is not feasible to equip drone landing sites for homes and small businesses with the sophisticated air traffic control and landing aid infrastructure systems that larger air vehicles require, but the architecture and methods of this disclosure involve only a simple and affordable ground based active NIR Landing Beacon that can be pre-programmed either automatically and remotely by the Supplier or the Drone Operating Company, or by the user, with a one-time delivery code obtained from the consignment Supplier or the Drone Operating Company, or alternatively linked to a dedicated software application on the Customer's mobile phone or domestic communications device, all in combination with an NIR sensor system on board the drone working in tandem with the drone's flight control system.

There is much prior art in the field of precision landing aids for autonomous drones, including the use of IR sensors on the drone and beacons on the ground [see for example Ref 2]. Due to the favourable characteristics of IR light transmission over the relatively short distances involved in drone landing and through a wide range of atmospheric day or night conditions, the use of IR tracking has many benefits and can, in principle, enable accurate drone landing in a wide range of weather conditions and at night in an inconspicuous manner with minimal light pollution as well as in daylight or full sunlight. The methods described in WO2022/003343 are improved here to include the use of narrowband NIR LEDs on the Landing Beacon and compatible narrowband IR filters within the IR Sensor on the drone to make the whole system provide for accurate drone manoeuvring and landing from a typical drone cruising altitude of around 100 m down to the landing area, a range far more than other known systems.

Furthermore, what is required in combination with accurate landing from transit altitudes, is the means to identify uniquely the intended landing site in a crowded urban environment where there may be many addresses in proximity more than one of which may be expecting a drone delivery. The combination of precision landing technology with the goods ordering process and its associated technologies into an overall set of systems and methods for the interaction of customers, suppliers and drone operators is the subject of this disclosure and has massive advantages for commercial drone operations, enabling in-city and urban as well as rural and more remote locations to participate in safe and secure drone collections and deliveries, whether the drones are piloted, semi-autonomous or fully autonomous.

It is therefore a further feature of the present disclosure that the ground based NIR beacon is active in that it can be used to transmit a code to the approaching drone that uniquely identifies the landing beacon as being the intended location for either the collection or the delivery of the consignment. The code can be entered into the beacons manually, for example using a numeric keypad, or the beacons can be connected to and work in combination with local communications infrastructure, for example domestic WiFi, such that the ordering process between customer and supplier results in the automatic transmission of order identification data to the beacon enabling the beacon to emit NIR radiation in a pulsed and coded manner. It is a feature of NIR Light Emitting Diode emitters (LEDs) that they can be switched on and off with short rise and fall times and hence are suitable for transmitting data to suitable NIR receiving sensors, each operating at compatible narrowband frequencies. Other technologies or combinations of technologies may also prove suitable for the transmission and receipt of a unique order code such as a one-time password between the precision landing aid on the ground and the delivery drone, for example radio frequency technology. In this way, as well as the system enabling the drone to navigate precisely and land at the collection or delivery site (or hover at the delivery site), the system ensures that the drone can autonomously identify the correct collection or delivery site prior to transferring the consignment on or off board.

It is yet another feature of the present disclosure that the system onboard the drone is not intended to be fitted with sophisticated sensors, computing, machine learning, artificial intelligence, or other advanced technologies capable of autonomously assessing the condition, state, or occupation of the landing site. The wider system of interest viewpoint taken by the present disclosure ensures that the delivery customer owns and takes responsibility for the landing site, as does the supplier for the collection site. The NIR Landing Beacon is placed in a specified position at the landing site by the supplier or customer and switched on and provided with the order identification code either manually or automatically in time for the drone arrival. Hence the consignment supplier or customer is responsible for the condition, state, and occupation of the landing site at the time of collection or delivery. The customer is also responsible for readying the landing site in preparation for a delivery in their absence. In this case the customer is responsible for the security of the site to prevent changes in its state or occupation prior to the landing. A foreseeable exceptional case is the ingress of wildlife, although the arrival of a drone is highly likely to scare them away.

According to an embodiment of the present disclosure there is provided a drone landing system for assisting in the autonomous, semi-autonomous or manual loading or unloading of a consignment onto or from a drone at a fixed geographic location, the drone delivery being part of the response to an order placed by a customer or a supplier for a small consignment suitable for transport by a drone, the drone landing system comprising: an active NIR Landing Beacon placed on the ground at or near to the delivery site incorporating at least one active NIR emitter, or at least one passive NIR emitter together with an alternative technology transmitter, the at least one NIR emitter having a field of illumination and being configured to emit narrowband NIR radiation at an appropriate intensity towards the delivery drone as it approaches (possibly determined by anticipated/scheduled arrival time) approximately the location of the delivery landing site and the active NIR radiation or alternative technology radiation being encoded with unique identification data associated with the planned delivery; one or more compatible narrowband NIR sensors fitted to the drone having a field of regard and sensitivity suitable to detect the one or more NIR emitters on the Landing Beacon and configured to receive the data either from the active NIR emitter or from an alternative technology emitter which uniquely identifies the landing site for the planned collection or delivery; a processor or processors on the drone configured to calculate (typically continuously) the position of the drone with respect to the ground beacon based upon the IR radiation detected by the one or more IR sensors and to control the flight trajectory of the drone to approach and land in proximity to the ground landing aid or to approach and hover above the landing aid whilst the consignment is lowered and released; a device such as a mobile telecommunications device (phone or computer) with application software installed that allows the customer to place an order with a supplier, the order to be delivered by drone and unique order identification and other data such as a scheduled landing time window (LTW) to be communicated both to the drone and to the ground Landing Beacon such that the Landing Beacon can transmit the order identification data for receipt and recognition by the correct delivery drone enabling the correct delivery drone to identify the correct landing site.

In some embodiments, and in all that follows, the NIR sensors and emitters may be replaced by IR devices operating in different infrared bands, for example short wave, medium wave, or long wave infrared, the latter two being known as thermal infrared, or by electromagnetic sensors and emitters operating in other parts of the spectrum. The primary advantage of NIR sensors and emitters is cost, typically a factor of 20-30 over thermal counterparts of similar performance and resolution. Thermal sensors would be able more efficiently to detect stray animals and humans but disadvantageously at significant weight and cost penalties to the drone—they are not ruled out however as additional sensors to the NIR architecture described in the primary embodiment as outlined.

In some embodiments, the Landing Beacon may be a development or enhancement of a standard mobile phone whereby the NIR emitter is an integral part of the mobile phone and the whole is used as a Landing Beacon and placed at the intended landing site. For very small consignments the customer may stand on the landing site holding the Landing Beacon in one hand and take receipt of the consignment in the other hand.

In further embodiments, the drone may use an appropriate technology such as a radio transmitter to transmit a delivery request message to potential Landing Beacons and the Landing Beacon be fitted with the corresponding technology to receive the delivery request and respond with an acknowledgement NIR active LED transmission. In the case of the Landing Beacon using the NIR emitter actively to transmit the unique order delivery code, this has the advantage of the NIR emitter being on only when requested to transmit thus reducing the power and hence capacity of battery required by the Landing Beacon.

In further embodiments the NIR sensors may be part of the landing aid on the ground and the NIR emitters may be on the drone, with the drone tracking information relayed continuously and in real time from the ground equipment to the drone. It is obvious how the smart infrastructure aspects of the disclosure would read across in this transposed architecture. This would be more akin to the architectural and methodical approach taken to drone transport networks in WO2022/003343. However, in the case of a drone landing system, there are limited other uses for the drone tracking information than to assist the drone in landing, hence placing the sensors and tracking computation in the drone itself is optimal. Furthermore, in the case of commercial drone deliveries, the ground infrastructure is something that must be replicated in potentially every home and business. The landing aid on the ground is therefore a system component that needs ideally to be as simple, affordable, and durable as possible—like a satellite broadcast receiving dish.

In a further embodiment, an active NIR Landing Beacon is placed adjacent to a collection site at a supplier's place of business such that a delivery drone can land in a similar manner to that described above, for the purpose of collecting a delivery consignment. The Landing Beacon and drone inter-operate in a similar manner to ensure the drone lands accurately on the landing site and in this case the supplier is responsible for the readiness of the landing site. In certain embodiments the drone delivery services can be provided by dedicated drone operating companies serving several suppliers and customers within a geographical area. Order identification data is therefore communicated to the supplier's Landing Beacon and to the drone so that a drone dispatched from a drone operating company can correctly identify and land at a supplier's site.

In some embodiments of the aspects above, the NIR Landing Beacon has 2 or more NIR emitters fixed to its structure with standard separation distances between them. These standard distances are such that the drone's downward looking NIR sensor and the associated computing on the drone can, by simple comparison of the detected apparent separations with the actual standard separations stored as constant parameters in the drone's computing memory, calculate at least the altitude and the latitude/longitude offset of the drone from the landing beacon, thereby enabling precise navigation and accurate landing in proximity to the landing beacon without the need for additional sensors on the drone, for example to measure altitude. In other arrangements the NIR Landing Beacon has just one NIR emitter fixed to its structure and the drone uses that one emitter to calculate latitude/longitude and uses an onboard sensor such as a radar altimeter to measure altitude. The precise pitch, roll and yaw situation of the drone are known to the drone's flight control system and may be used for calculations in situations where the drone's orientation is not adequately stable.

In embodiments where there are more than 2 NIR emitters fixed to the landing beacon in standardised arrangements then more sophisticated self-position and self-track geometrical calculations may be performed by the drone. Only one of the NIR emitters on the landing beacon needs to be configured to transmit the order identification data, although more than one may be enabled to do so for reliability/availability reasons.

In some embodiments, the NIR emitters are replaced by NIR retroreflectors. This embodiment is used in cases where the drone is provided with one or more NIR emitters or lamps which are configured to emit NIR radiation toward the landing beacon where it is retroreflected back towards the drone where it is detected by the NIR sensor and used to assist tracking and landing as described above. In this embodiment the drone has limited ability to receive information from the ground beacon and verify the correctness of the landing site, for example the retroreflector may be designed to embody a QR Code or Bar Code or other pattern that the drone system is programmed to recognise. However, the cost of the landing beacon would be reduced significantly, and this may be advantageous in some markets or situations. Furthermore the NIR emitter(s) on the drones may be synchronised with the NIR sensor so that they emit IR radiation only for the very short periods when the sensor has been activated to absorb IR radiation, thus reducing the demand on the drone's power supply. The duty cycle in this case would typically be only 5%. In further embodiments in which the NIR emitters are located on the landing beacon, the NIR emitters and the NIR sensor on the drone may similarly be synchronized. Examples of how this synchronization may be achieved include the transmission of an appropriately configured RF signal between the drone and the beacon, and through the use of synchronized clocks on each of the beacon and the drone (e.g. using GPS received time).

In some embodiments the NIR emitters on the Landing Beacon are replaced by filament bulbs which tend to have good IR illumination across the whole IR band.

In some embodiments, the drone landing or lowering site need not be on the ground or atop a building but may be on a moving vehicle such as a lorry, car, van, train, ship, boat, second drone, etc. This enables the transfer of consignments between different modes of transport or the transfer of consignments between drones or other aircraft. In this arrangement the coarse positioning of the delivery/collection drone is again achieved by standard means such as GPS/INS, with the receiving vehicle transmitting its location at regular intervals to the delivery drone. In cases where the receiving vehicle may not have the necessary standard positioning equipment then the drone Landing Beacon itself, as described above, may incorporate the GPS/INS or other standard tracking equipment and the equipment to transmit its location to the delivery drone. In these arrangements, the precise “landing” of the drone on the moving vehicle is achieved as described above.

Whilst the above embodiments are based on delivering goods as part of a commercial transaction, they apply equally to alternative scenarios such as the delivery of medicines from a health service provider or the delivery of essential supplies in emergency or humanitarian relief situations. They apply in all cases where there is a need or opportunity for drones to uniquely identify the correct collection and delivery sites and land accurately, safely, and securely at the correct collection and delivery sites be they static or on other vehicles or moving entities.

It is to be appreciated that references made herein to a drone may refer to a variety of mobile flying objects of any scale or size. By way of a non-exhaustive list, these flying objects may include drones of any size, aircraft, lighter than air vehicles, air taxis, and flying cars. These flying objects may additionally be configured to be operated manually by a user, or may be configured to be autonomous, or a combination of the two, namely semi-autonomous. In situations where the vehicle is not autonomous, the sensor and navigation data may be communicated in real-time from the vehicle to a remote pilot.

The above-described features of the embodiments of the disclosure are combinable in different ways and can be added to the following specific description of the embodiments of the present disclosure if not specifically described therein.

Specific embodiments are now described with reference to the appended figures.

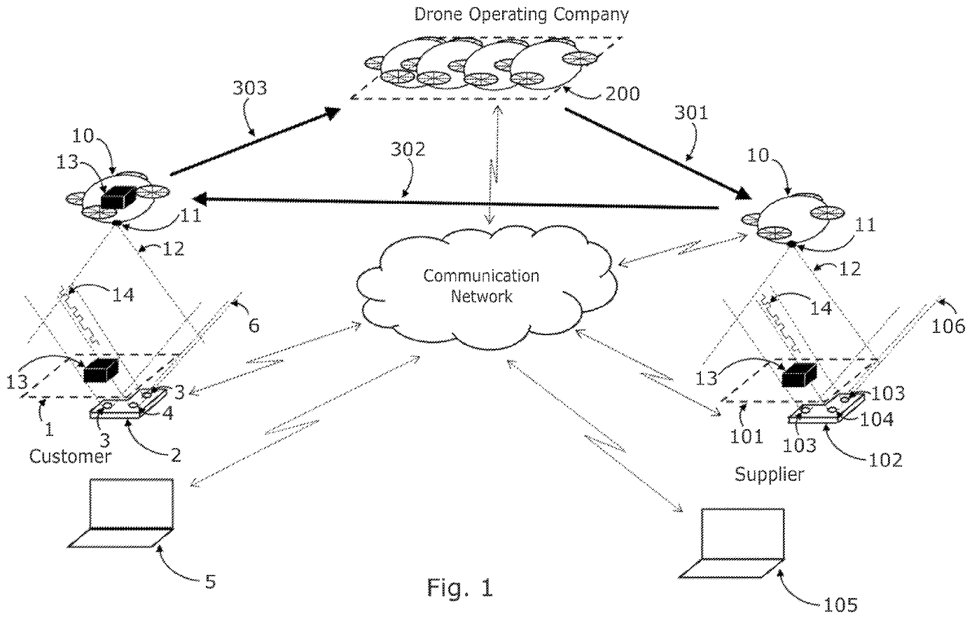

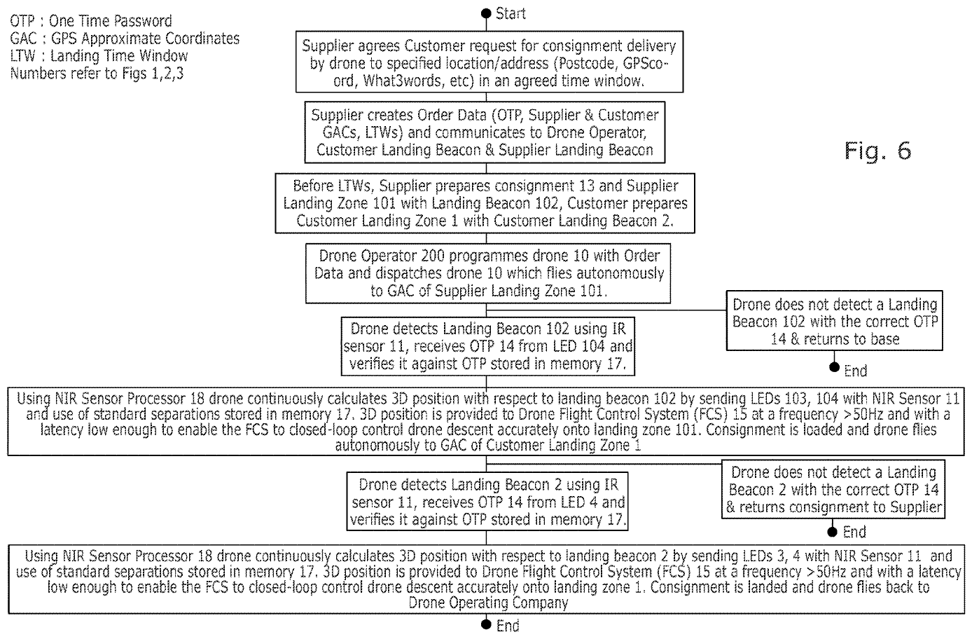

Turning firstly to FIG. 1, there is shown an overview of the complete system of interest as deployed for the ordering, dispatch, and delivery by drone of a small consignment from a supplier to a customer. In the following description, the term “drone” is used for ease of reference, however it is to be appreciated that the drone may be substituted for any airborne vehicle suitable for use with the described features. Reference should also be made to FIG. 6 which is a flow chart description of the principal functions and methods of operation of the system of interest. The customer premises include an area 1 suitable for a drone to either land on or hover above and deliver the consignment. The customer places the order with the supplier, typically using their own communications device 5 (computer, phone, etc) and over a communication network. Assuming the supplier has an arrangement with the drone operating company then the supplier uses its communications device 105 to place a request for a drone to be dispatched from the drone operating company base 200 and carry out the round trip 301→302→303. In instances where such an arrangement is not already in place, the supplier may look to obtain either a temporary or permanent arrangement to request a drone upon receipt of the order. In some instances, the supplier themselves may operate their own drones. In such instances, it is not necessary for the supplier to place a request and may simply operate their own drone to carry out the round trip in accordance with the following description.

The customer order is allocated a unique identification code for example a six-digit One-Time Password (OTP) by the supplier and the code is communicated to the allocated drone 10 and to the supplier landing beacon 102 and the customer landing beacon 2, all of which are configured to receive such data, typically via wireless communication. However, the landing beacons 2 and 102 may also provide the means for the order code to be entered by wired communication or manually via a keypad. In some embodiments, the unique identification code may be provided to identify a particular customer as opposed to a particular customer order. This may be beneficial in instances in which repeat deliveries to the same customer in the same location are to be expected. In such instances, it may be more procedurally efficient to provide an identification code for the customer location which is used for each customer order which is to be provided to that customer location. If a single customer is associated with a plurality of customer locations, a unique identification code may be provided for each of the associated locations.

In addition to the unique identification code, further data may be provided to the allocated drone 10 such as the scheduled Landing Time Windows (LTWs) and the GPS Approximate Coordinates (GACs) of both landing sites. LTW data would also be communicated to the supplier and customer via the communication network and their own communications device 5 so that the supplier can prepare the goods and the landing site 101 and the customer can prepare the landing site 1 at the appropriate times.

The drone 10 is configured to receive the unique order identification code, LTWs and GACs and navigate at its transit altitude using standard equipment such as GPS/INS along route 301 to the GAC of the supplier landing site 101. This navigation may be achieved autonomously through use of appropriately configured self-guidance systems on the drone 10. Alternatively, the navigation may be achieved manually, with a drone pilot remotely navigating the drone 10 to the GAC of the supplier landing site 101. In some embodiments, a combination of autonomous and manual navigation may be used to cause the drone to travel to the GAC of the supplier landing site 101.

When positioned approximately vertically above the site 101 the drone uses its substantially downward facing NIR sensor 11 to correctly identify and then track the (in this example) three NIR emitters 103 and 104 within the sensor field of view 12. The emitters 103, 104 are part of the landing beacon 102 that the supplier positions adjacent to the supplier's landing area 101. In this case the L-shape arrangement of the emitters 103 and 104 uniquely identifies the position of a square landing site which may be of a standard dimension (e.g., 1 metre square) which is a fixed parameter in the drone's on-board computer system memory. It is to be appreciated that the example of a square landing site is provided by way of illustration only, and that any appropriately configured dimensions of a compatible landing site may be used. Additionally, the use of an L-shape arrangement for the emitters is also provided as an illustrative example only, and any configuration which uniquely identifies the position of the landing site (landing area) may be utilised.

If the landing beacon has only 2 NIR emitters, then an established convention could be that the device is always placed on the north edge (say) so that the drone can land precisely within the area 101. If the landing beacon has only 1 NIR emitter then the convention may be the north-east corner, say. These positions are provided by way of illustrative example only and any appropriately configured position convention could be used. However many emitters there are, at least one is configured to transmit the unique order identification code by modulation of its NIR signal (in this embodiment) such that the drone can receive the code, compare with its stored code, and confirm the landing site 101. The modulated signal may be detected and received by the same sensor on the drone 10 used to locate and track the beacon emitters or it may be received by a separate and independent sensor. In another embodiment, an alternative technology may be used for this communication as described above. In addition, tracking the emitters 103 and 104 provides the navigation system onboard the drone with the real-time data necessary to control its descent and land precisely within the landing area 101.

The consignment 13 can then be loaded manually into the landed drone. The accuracy provided by this method of landing is so precise that it enables the drone 10 to be configured with an automatic collection mechanism, for example a hatch and latch arrangement. The drone 10 can then descend onto the consignment 13 which has been placed at a precise and standardised position within the landing area 101, before securing the consignment 13 and departing, the complete collection having been performed autonomously. The drone then takes off and transits along route 302 to the GAC of the Customer's delivery landing area 1. When positioned approximately vertically above the site it uses its downward facing NIR sensor 11 to correctly identify and track the (in this example) three NIR emitters 3 and 4 within the sensor field of view 12. The emitters are part of the landing beacon 2 that the Customer has positioned adjacent to the Customer's landing area 1. Once again, the arrangement of emitters 3,4 of the landing beacon 2 defines the landing area 1 to the drone 10. Another precise landing manoeuvre is executed at the customer site, the area having been prepared and secured by the customer. The drone then releases the consignment 13 autonomously and returns along route 303 to base 200. It is to be appreciated that transit of the drone 10 to the customer GAC is analogous to the transit to the transit of the drone to the supplier GAC and that this may be achieved autonomously, manually or a combination of both in accordance with the description provided above.

In some use scenarios of the described system, the drone may simply be configured to arrive at a particular landing area without requiring collection or delivery of a consignment 13.

If the drone arrives at the Supplier's GAC in the appropriate LTW and does not detect a Landing Beacon with the correct identification code, then it returns to base. If the drone collects the consignment from the Supplier and then arrives at the Customer's GAC in the appropriate LTW and does not detect a Landing Beacon with the correct identification code, then it either returns the consignment to the Supplier and returns to base or takes the goods back to base or to some other intermediate storage location until the delivery can be rescheduled and returns to base. Each of these transits may be achieved analogously to the transit to the supplier and customer GACs detailed above.

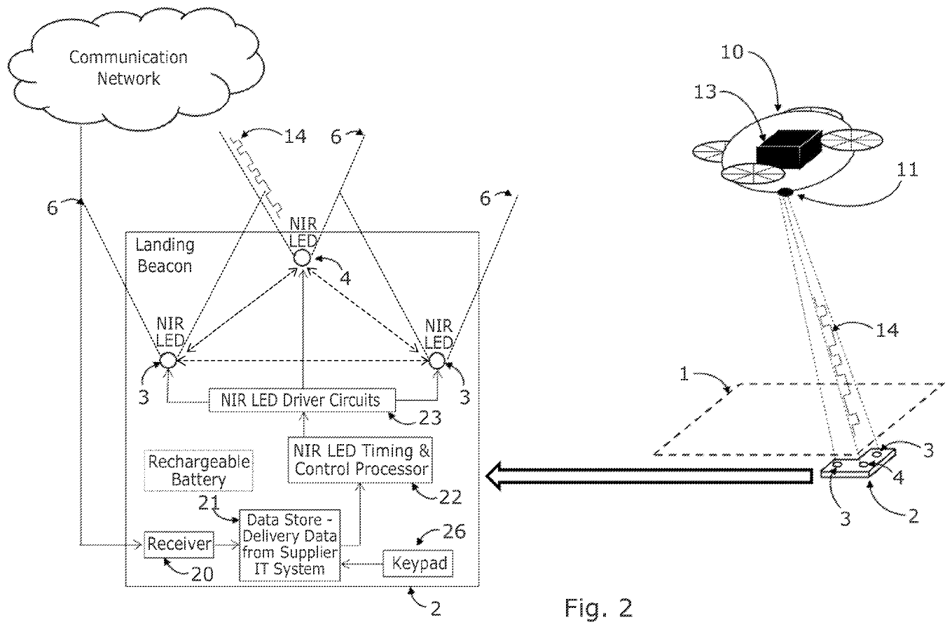

Referring now to FIG. 2 there is shown in greater detail a view of the same scenario as FIG. 1 but focused on the Customer landing site and the customer landing beacon 2. The landing beacon firstly comprises a receiver 20 configured to receive incoming data in accordance with embodiments above. In particular, the receiver 20 is configured to at least receive unique delivery identification data from the supplier or from the Drone Delivery Company or Supplier Company relating to the one or more delivery orders that the customer has made, in accordance with embodiments described above. The unique delivery data includes at least a unique delivery code and may include the planned landing time window (LTW) of the drone delivery. The receiver 20 may be configured to receive this data via radio frequency communication. Alternatively, the receiver 20 may receive this data using any suitable form of communication, which enables the data to be received from the drone company or supplier. In some embodiments, the receiver 20 is configured to receive data through wired communications or manual data entry via keypad where appropriate.

The landing beacon 2 of the current embodiment further comprises a data store 21 and a processor 22, which is communicably coupled to the data store 21 and possibly to the receiver 20 or a data entry keypad 26. The processor 22 may be configured to receive data which is received by the receiver 20 or keypad 26 (such as the unique delivery code and the LTW) and store it in the data store 21 in accordance with embodiments described above. The processor 22 is configured to control the NIR LEDs 3 and 4 using appropriate driver circuits 23 so that the passive LEDs 3 are activated continuously, and the active LED 4 is activated and modulated by the unique order code 14 once the order data has been received or alternatively just within the LTW that the drone delivery is expected, possibly stimulated by a delivery request signal from the drone as described above. In terms of communication by NIR transmission a unique 6-digit order code requires 20 bits of data which can be transmitted repeatedly once a second and received by an NIR sensor on the drone operating at 60 HZ whilst still ensuring that the emitter is continuously illuminated for two thirds of each second to support the tracking function. In some instances, the sensor may be configured to operate at a frequency of anywhere between 25 Hz and 200 Hz. The use of higher frequency NIR sensors and NIR emitters in other embodiments reduces the proportion of modulation time. The field of illumination 6 of each of the upwards facing NIR LEDs is typically a cone shape with a cone angle such that, at the altitude at which the drone is flying before it commences descent to the landing area, the area of the circle of illumination at that altitude is greater than the uncertainty in the navigation accuracy of the standard navigation systems, e.g., GPS/INS, on board the drone—i.e. the uncertainty in the GAC that the drone has navigated to. In this way the drone can approach the GAC of the landing site using its on-board standard navigation systems and then be guided precisely to the landing zone 1 using the illumination from the landing beacon 2.

In the case that there are several potential landing addresses within the area of approximate location that the standard navigation technologies can achieve and in the case that there is more than one landing site expecting a drone delivery, the unique code transmitted by the correct landing beacon ensures that the correct delivery is made. The same principle applies to the correct selection of Supplier collection landing zones that are in proximity, and particularly in urban areas where many suppliers may be within the GAC of any single supplier.

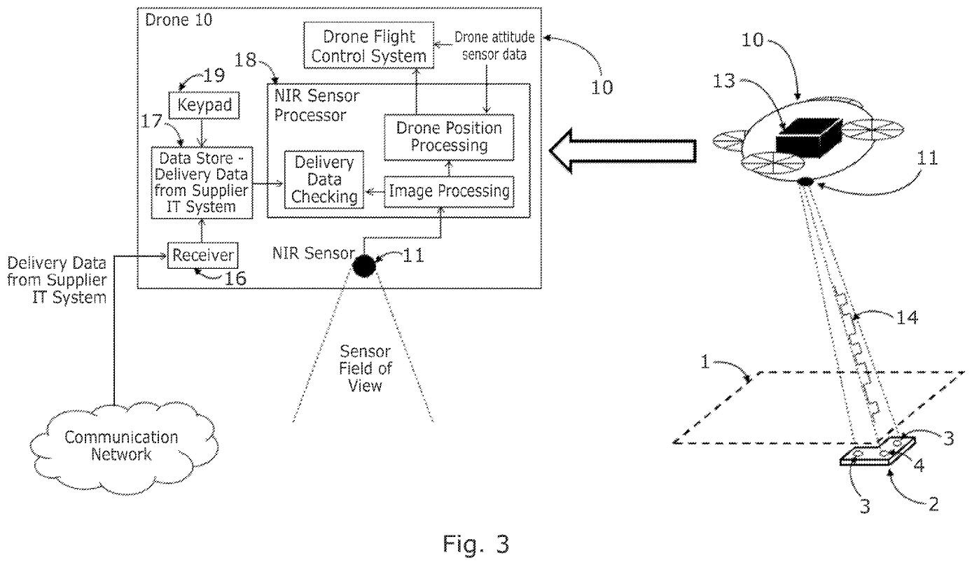

Referring now to FIG. 3 there is shown in greater detail a view of the same scenario as FIGS. 1 and 2 but focussed on the drone 10 above the customer landing site 1 and showing a schematic view of the drone on-board systems. The drone firstly comprises a receiver 16 configured to wirelessly receive incoming data in accordance with embodiments above. Again, the drone may receive this data via other mechanisms such as wired communications or manual data entry. In particular, and similarly to the landing beacon, the receiver 16 is configured to at least receive unique delivery data from the supplier or from the drone delivery company relating to the one or more delivery orders that the customer has made. The unique delivery data includes at least a unique delivery code and may include the planned time window (landing time window (LTW)) of the drone delivery. The receiver 16 may be configured to receive this data via a radio frequency communication. The unique delivery data may additionally include the GAC of the supplier and customer landing sites in order to enable the drone to navigate autonomously (or otherwise) to the appropriate approximate locations.

The drone of the current embodiment further comprises a data store 17 and a processor 18, which is communicably coupled to the data store 17 and to the receiver 16 and an optional keypad 19. The processor 18 may be configured to receive data which is received by the receiver 16 or keypad 19 and store it in the data store 17. The processor 18 is configured to receive images from the NIR sensor 11 at a frequency suitable for use in closed-loop accurate flight control, typically 50 Hz or more. According to the embodiments above, the drone has used its standard navigation systems, e.g., GPS/INS, to be in such an approximate position and orientation relative to the landing beacon 2 that the images of the IR emitters 3, 4 on the landing beacon 2 are within the field of view of the NIR sensor 11. In some embodiments, this is enabled by the provision of the GAC of the relevant landing sites to the drone 10 in accordance with embodiments described above. The processor then performs analysis of those images, made possible in close to real time by the matched combination of narrowband NIR emitter(s) on the landing beacon and one or more NIR filters on the drone's NIR sensor which provides for a high signal to noise & clutter ratio in the NIR imaging. The on-board system uses the known and standardised separations (see FIG. 2) of the NIR emitters 3, 4 which are stored as constant parameters in the processor's local memory together possibly with information about the current attitude (e.g., pitch, roll, yaw) of the drone 10 itself, to determine the drone's precise current position in three dimensions in relation to the landing beacon 2. Such altitude information may be enabled by the provision of an appropriately configured sensor on the drone 10 or may be provided to the drone 10 via the receiver 16 (or a separate receiver). In the case of only one NIR emitter on the landing beacon 2, the drone uses its imaging of that emitter together with data from other sensors, for example a radar altimeter, to perform the same positioning determination. This processing is done at a frequency high enough and latency low enough that the precise current position can be communicated by the processor 18 to the drone's flight control system to enable it to manoeuvre the drone precisely down along a flight path to land in the desired position in relation to the landing beacon.

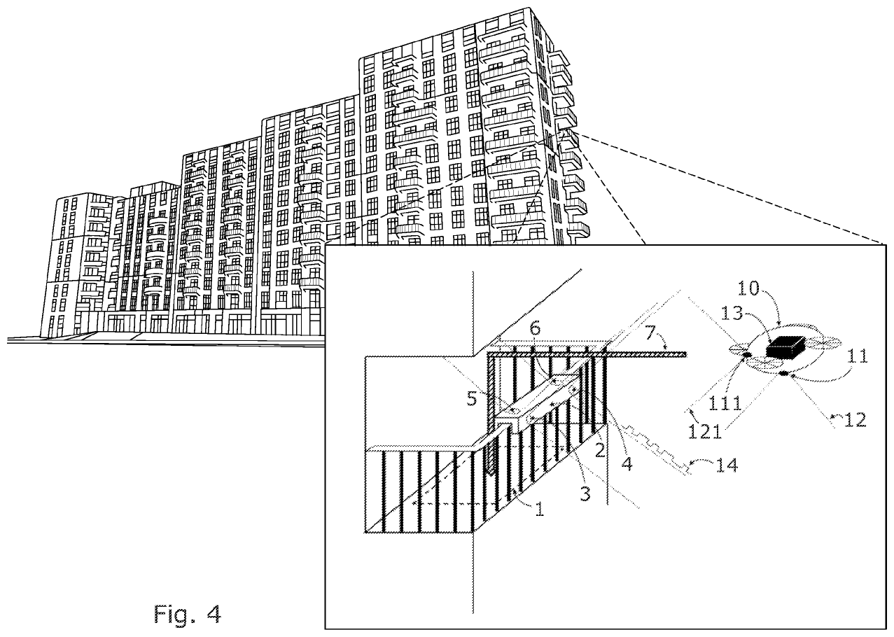

Referring now to FIG. 4, there is shown a view of a Drone and Landing Beacon in an alternate use scenario where the drone must perform a precise manoeuvre transitioning from a horizontal approach to a short vertical descent, or to hover whilst a consignment is lowered, onto the precision landing site 1 on balcony of a high-rise building. This is achieved by the drone being fitted with two complementary NIR sensors 11 and 111 with fields of view 12 and 121 suitable for detecting NIR LEDS on a Landing Beacon 2 that are arranged in pairs with complementary fields of illumination to facilitate the manoeuvre in an obvious manner.

At least one of the horizontally facing NIR LEDs operates in an active manner to enable the drone to identify the landing site correctly using the unique code 14 before commencing its approach close to the building. This is a particular scenario where standard positioning technologies such as GPS can be extremely inaccurate or unreliable and where there may be several potential landing sites in proximity from which the correct one must be identified.

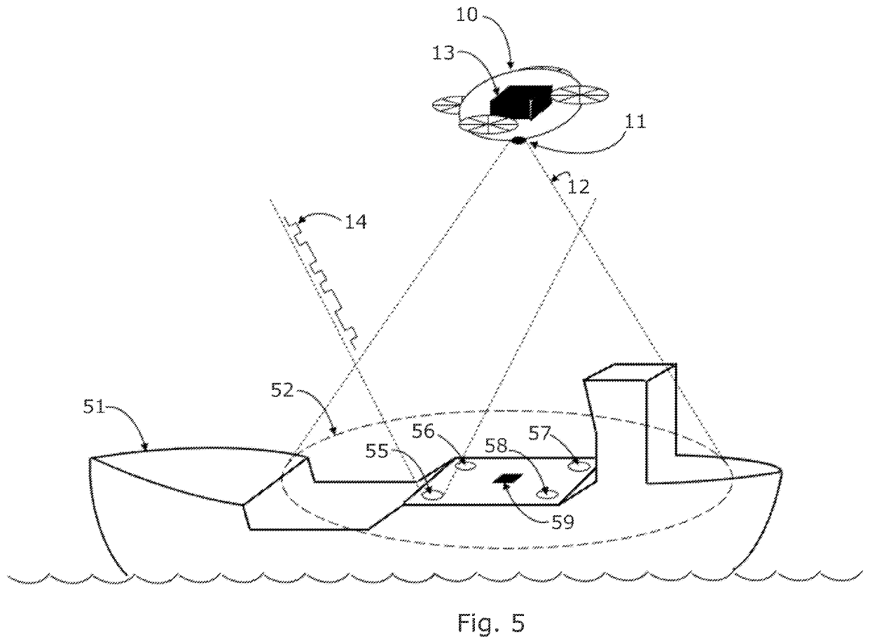

Referring now to FIG. 5 there is shown a view of a drone and a Landing Beacon in a further alternate use scenario as an example of one where the landing site is in constant motion. In this case the precise landing site 59 is surrounded by at least three NIR LED Landing emitters (four shown here, 56-59) and at least one of those is an active LED emitter, or there is an alternative communication technology on board the ship, to transmit the unique identifier code to the drone. At least three Landing emitters are required so that the drone can compute both the orientation of the ship deck as well as the relative position of the drone in relation to the deck at the same time. In this way the drone, or a large aircraft such as a helicopter or vertically landing plane, can calculate and execute in real time a landing manoeuvre that ensures the aircraft and the moving deck are in both suitable relative positions and suitable relative orientations for a safe landing.

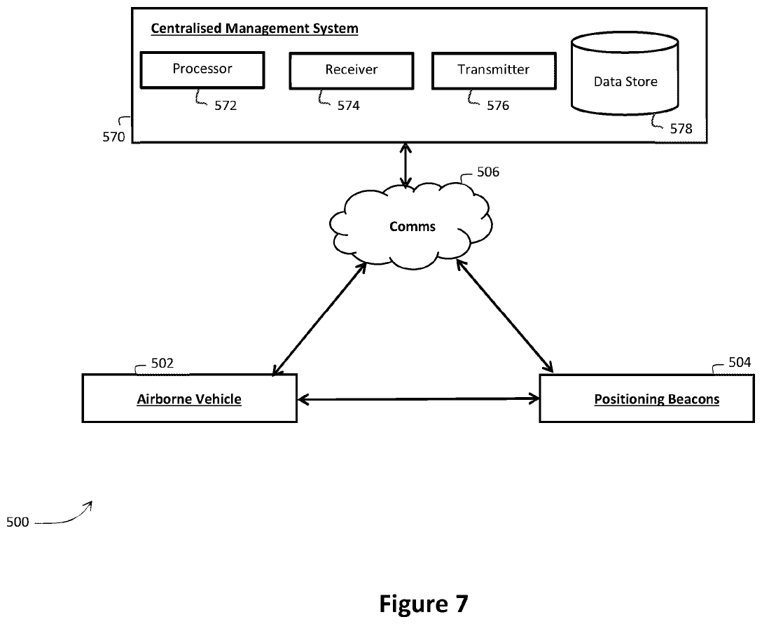

The above description has been provided against the backdrop of a use scenario in which a drone is configured to perform a delivery of a consignment to a predefined location. Further description of a general use scenario for the above-described technology is now provided with reference to FIG. 7. In particular, this figure illustrates a general-purpose system 500 provided in order to precisely position an airborne vehicle. It is to be appreciated that the features and methods described in the above embodiments may be equally used in combination with the general-purpose system.

Referring to FIG. 7, there is shown a system 500 for positioning an airborne vehicle. The system 500 includes the airborne vehicle 502 to be positioned, and one or more positioning beacons 504 which are provided to guide the airborne vehicle 502 to a precise position. In particular, the one or more positioning beacons 504 are configured to enable the airborne vehicle 502 to position itself precisely relative to the one or more positioning beacons 504, either by hovering in the air or by landing on a nearby surface. Both the airborne vehicle 502 and the one or more positioning beacons 504 may be configured to enable communication with an external communications network 506. This configuration enables the airborne vehicle 502 and the one or more positioning beacons 504 to receive data from, and provide data to, devices outside of the system 500. This can enable additional functionality of the system 500. In some embodiments, the airborne vehicle 502 and the one or more positioning beacons 504 may also be communicably coupled, either through direct communication between the two, or via the external communication network 506. It is to be appreciated that communication via the external communication network 506 may be achieved wirelessly or through wired means where appropriate.

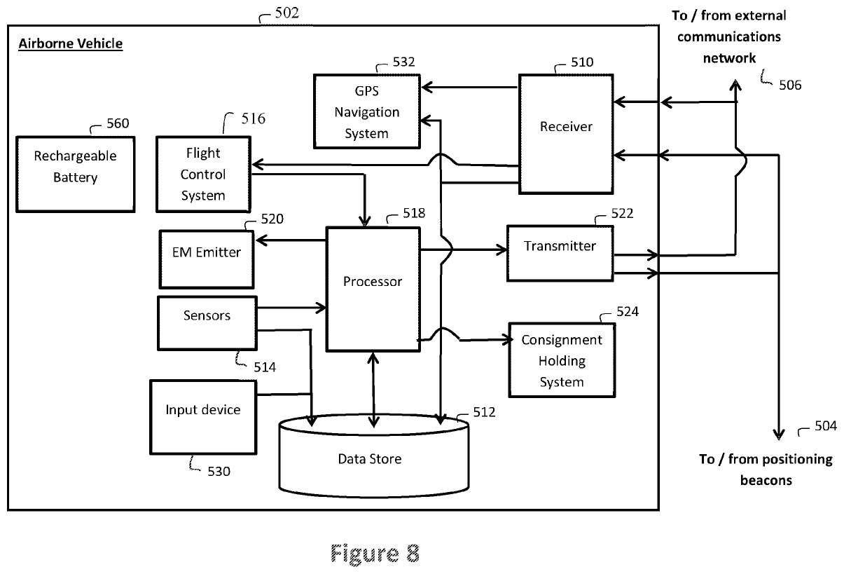

FIG. 8 illustrates a schematic view of an airborne vehicle of the general-purpose system 500. The airborne vehicle 502 is firstly provided with a receiver 510. The receiver 510 may be configured to receive unique identification data from the external communication network 506. The identification data provides the airborne vehicle 502 with a means of confirming with a positioning beacon 504 that the airborne vehicle 502 is in the correct general location that it is intended to be in (although may not be in the required precise position). Typically, the identification data will comprise a form of unique identifier which identifies a specific positioning beacon 504 which the airborne vehicle 502 is to position itself relative to. In accordance with embodiments discussed above and below, the relevant positioning beacon 504 is configured to transmit a landing identifier, which is then received by the airborne vehicle 502. The airborne vehicle 502 is then configured to compare the landing identifier received from the positioning beacon 504 with the unique identifier received from the external communication network 506. The landing identifier is provided in order for the airborne vehicle 502 to determine the correct positioning beacon 504 with which it is to be positioned. Specifically, the unique identifier provided to the airborne vehicle 502 will be configured to match the landing identifier to be transmitted by the positioning beacon 504 which the airborne vehicle 502 is configured to position itself with respect to. Upon comparing the unique identifier and the landing identifier, if the two identifiers match, then the airborne vehicle 502 determines that it is to position itself relative to this specific positioning beacon 504. In some embodiments, there may be a plurality of beacons 504, each transmitting a different landing identifier. In these cases, if the airborne vehicle 502 receives a landing identifier which does not match the unique identifier received from the external communications network 506, it will determine that it should not position itself relative to the beacon 504 which provided the non-matching landing identifier. The unique identifier and the corresponding landing identifier may comprise an OTP in accordance with embodiments described above. Alternatively, the data may comprise any form of information which enables the airborne vehicle to confirm with a positioning beacon 504 that it is in an approximate intended location.

The provision of this identification data may be particularly advantageous in circumstances in areas in which there are many beacons 504 present of the type described, For example, in an urban area comprising many properties, each property may be provided with a beacon 504 to enable an airborne vehicle 502 to be positioned relative to it, for example where the airborne vehicle is configured to deliver items to each of the properties. Where identification data is not provided, it may be difficult to establish which of the beacons 504 the airborne vehicle 502 should position itself relative to, since each beacon may be otherwise substantially identical. Furthermore, existing systems which identify general locations (e.g. GPS coordinates) can be inaccurate in urban areas where reception can be unreliable, or otherwise not sufficiently precise in relation to the spacing between properties. When the identification is provided and subsequently confirmed, the airborne vehicle 502 is able to precisely identify which of the beacons 504 it should position itself relative to in a more accurate manner than is possible in accordance with known systems.

The receiver 510 is communicably coupled with a data store 512. The data store 512 is configured to receive the identification data from the receiver 510 and retain this data in an appropriate format to be subsequently retrieved. The airborne vehicle 502 is further provided with one or more sensors 514 configured to detect electromagnetic radiation being emitted or reflected from the one or more positioning beacons 504. In accordance with embodiments described above, this electromagnetic radiation may be in the infrared spectrum. More specifically, the radiation may be Near Infra-Red (NIR) and in some instances, narrowband NIR may be used. The one or more sensors 514 are appropriately configured to detect the specific radiation being emitted from the one or more positioning beacons 504. As an example, where the radiation being emitted is of the NIR format, the one or more sensors 514 may be provided with an NIR filter in order to reduce noise and maximise the signal to noise ratio from the detected beacon when detecting the emitted radiation. In particular, the one or more sensors 514 are configured to detect the electromagnetic radiation and also to detect a directionality from which the radiation is received. This directionality may enable the airborne vehicle 502 to precisely position itself with respect to the one or more positioning beacons 504 as will be detailed below. In embodiments in which NIR and/or narrowband NIR is utilised in the system with an appropriately configured filter, the system may advantageously achieve detection ranges up to an altitude of approximately 100 m, Such ranges may typically not be achievable when using other radiation bands due to imprecision associated with the associated wavelength ranges. This detection range is particularly advantageous since 100 m is a typical cruising altitude of certain types of airborne vehicles in urban areas and therefore no specialised manoeuvering would be required in order for the airborne vehicle 502 to detect the radiation being emitted from the positioning beacons 504. In some embodiments, the information from the sensors 514 is stored in the data store 512.

In addition, the receiver 510 may be configured to receive positioning data from the external communication network 506. This positioning data may provide an indication of where the airborne vehicle 502 should be positioned relative to a source of emitted or reflected electromagnetic radiation (i.e., from the corresponding one or more positioning beacons 504). This may be enabled by pattern recognition of the emitted or reflected electromagnetic radiation and/or by the provision of supplementary data. This will be discussed in greater detail below with reference to the description of the one or more positioning beacons 504. Similarly to the identification data, the positioning data may be stored in the data store 512 in an appropriate format to be subsequently retrieved. In some instances, the positioning data indicates a position in mid-air that the airborne vehicle 502 should be positioned relative to the source of emitted or reflected electromagnetic radiation. In other instances, the positioning data indicates a position on a surface (e.g., the ground) that the airborne vehicle 502 should be positioned relative to the source of emitted or reflected electromagnetic radiation. In some embodiments, the airborne vehicle 502 may be configured to land on a surface, but will be provided with a position in mid-air that the airborne vehicle 502 should be positioned relative to the source of emitted or reflected electromagnetic radiation. Once this position has been reached at a particular altitude, the airborne vehicle 502 may be configured to simply descend (i.e., reduce altitude), whilst maintaining the same latitudinal and longitudinal coordinates. Alternatively, the positioning data may provide information regarding the position of the airborne vehicle relative to the source of emitted or reflected electromagnetic radiation at a plurality of altitudes, ensuring that positional accuracy is maintained as the airborne vehicle 502 changes altitude. The combination of the provided positioning data and the monitoring of emitted or reflected electromagnetic radiation (and in particular using NIR or narrowband NIR) can enable the airborne vehicle 502 to both manoeuvre itself towards and then position itself precisely within an area of approximately 1 square metre.

The airborne vehicle 502 is further provided with a flight control system 516. The flight control system 516 comprises appropriately configured propulsion systems which enable the airborne vehicle to hover and manoeuvre and land and take off. The flight control system 516 is also configured to receive commands which instruct the flight control system 516 regarding how the airborne vehicle 502 is to be manoeuvred. In some embodiments, the flight control system 516 is communicably coupled to the receiver 510 and may be configured to receive commands via the external communication network 506 to manoeuvre the airborne vehicle 502.

The airborne vehicle 502 may be further provided with a processor 518. The processor may be communicably coupled to the data store 512 and the one or more sensors 514. The processor 518 is configured to utilise the information which has been stored in the data store 512 in order to enable to position the airborne vehicle 502 relative to the one or more positioning beacons 504 in accordance with the positioning data stored in the data store 512. To achieve this, the processor 518 may be configured to firstly receive identification data (including the landing identifier) from the one or more positioning beacons 504. The information received from the one or more positioning beacons 504 is configured to be in the same format as the unique identification data (including the unique identifier) stored in the data store 512. In some embodiments, the one or more positioning beacons 504 provide the landing identification data in a format configured to be received by the receiver 510. In other embodiments, the landing identification data is provided through appropriate communication between the one or more positioning beacons 504 and the airborne vehicle 502 via the external communication network 506. In yet other embodiments, the landing identification data is provided from the one or more positioning beacons 504 through appropriately modulated electromagnetic radiation which is emitted from, or reflected by, the one or more positioning beacons 504 in accordance with embodiments described above. In such embodiments, the landing identification data is therefore received via the one or more sensors 514, where the one or more sensors 514 are configured to identify the data from the received electromagnetic radiation in addition to detecting the radiation and the directionality of the radiation.

The processor 518 is configured to compare the landing identification data received from the one or more positioning beacons 504 to the corresponding unique identification information in the data store 512 to determine if they match. If they do not match, then the processor 518 identifies that it is in the wrong location and may be configured to cease any further positioning functioning. The airborne vehicle 502 may then be configured to perform further actions such as returning to a home location or await further instructions via the external communication network 506. If they do match, the processor 518 may then be configured to perform precise positioning of the airborne vehicle 502.

In such instances, the processor 518 receives information regarding the detected electromagnetic radiation and its directionality from the one or more sensors 514 (or alternatively retrieves this information from the data store 512). The processor 518 then retrieves the previously received positioning data from the data store 512. The processor 518 is configured to compare the above-mentioned information from the one or more sensors 514 with the received positioning data in order to determine whether the airborne vehicle 502 is positioned correctly in accordance with the positioning data. If it is determined that the position is incorrect, the processor 518 is configured to determine a set of manoeuvering actions which may be sent to the flight control system 516 in order to position the airborne vehicle 502 correctly. In some embodiments, the processor may not instruct the flight control system 516 directly, but instead may provide a set of recommended manoeuvres to a remote pilot via the external communication network 506 which enable the airborne vehicle 502 to be positioned correctly with respect to the one or more positioning beacons 504.

In some optional embodiments, the airborne vehicle 502 is provided with an electromagnetic radiation emitter 520 which is configured to direct electromagnetic radiation in the direction of the one or more positioning beacons 504. In these embodiments the one or more positioning beacons 504 are provided with reflectors configured to reflect the received electromagnetic radiation back toward the airborne vehicle 502. This reflected radiation may then be used in accordance with the embodiments described above.

In further optional embodiments, the airborne vehicle 502 is provided with a transmitter 522. The transmitter 522 may be configured to transmit any required information in accordance with the above embodiments. In particular, the transmitter 522 may be used to communicate data to an external pilot of the airborne vehicle 502 to enable them to control the airborne vehicle 502 and position it as required. In addition, in some embodiments, the transmitter 522 may be configured to continually transmit unique identification data to be received by the one or more positioning beacons 504. Upon receipt of the unique identification data, the one or more positioning beacons may transmit a receipt of the data to the airborne vehicle 502 which is received by the receiver 510 of the airborne vehicle 502. This receipt can then be used in an analogous manner to the receipt of the identification data as described in embodiments above.

In further embodiments, the airborne vehicle 502 may also be provided with a consignment holding system 524. The consignment holding system 524 is configured to enable the airborne vehicle 502 to carry a load when operating. This may be used in embodiments such as those described above where the airborne vehicle 502 is used as part of a consignment delivery system. The consignment holding system 524 may include any suitably adapted system which enables the airborne vehicle to carry an appropriate load. In some instances, the consignment holding system 524 also includes systems which enable the airborne vehicle 502 to autonomously receive and deliver a load based on the position of the airborne vehicle 502. In these cases, when the airborne vehicle 502 is positioned correctly in accordance with the embodiments above, the processor 518 is configured to operate the consignment holding system 524 to either collect or deliver the load. This may be achieved in accordance with the description above.

In some embodiments, the airborne vehicle 502 may be provided with a direct way of inputting the unique identification data via an input device 530. The airborne vehicle 502 is configured to store the data provided by the input device 530 in the data store 512. By way of example, the input device 530 may comprise a keypad, and the unique identification data may comprise a unique code, in accordance with embodiments described above.

In some instances, the airborne vehicle 502 may be provided with at least two sensors 514 with different fields of view. This may be utilised, for example, in certain instances where the one or more positioning beacons 504 are configured to emit or reflect electromagnetic radiation in substantially different directions. An example of such an instance is shown in FIG. 4 and described above.

In some embodiments, the airborne vehicle 502 also includes a GPS navigation system 532. The GPS navigation system 532 may be used to navigate the airborne vehicle 502 to an approximate location which is proximate to the positioning data prior to the airborne vehicle 502 being positioned precisely with respect to the one or more locating beacons 504. In such embodiments, prior to departure the airborne vehicle 502 may be provided with GPS coordinates indicating an approximate location to depart to. These may be provided in an analogous manner to the provision of the positioning data and/or the unique identification data described above. These may then be stored in the data store 512. In some cases, the processor 518 may be configured to retrieve these coordinates and instruct the flight control system 516 to navigate to the coordinates in an autonomous manner. In other instances, the airborne vehicle 502 may be controlled by a remote pilot to achieve the same effect.

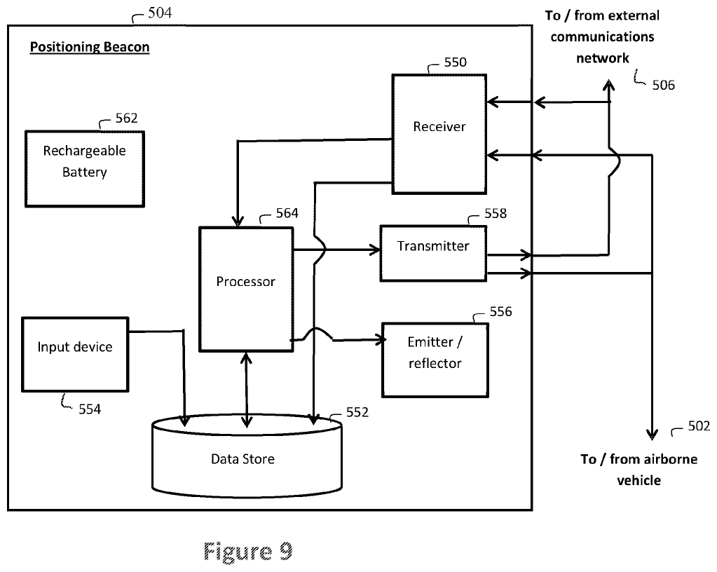

Turning now to FIG. 9, there is shown a schematic diagram of one of the positioning beacons 504. the beacons 504 are provided with a receiver 550. The receiver 550 may be configured to receive landing identification data from the external communication network 506 in a manner analogous to the airborne vehicle 502 above. The landing identification data provides the beacons 504 with a means of confirming with the airborne vehicle 502 that the airborne vehicle 502 is in the correct general location that it is intended to be in (although may not be in the required precise position). As discussed with reference to the airborne vehicle 502 above, the landing identification data will typically comprise a form of landing identifier for the beacon 504 which identifies the beacon as being one which the airborne vehicle 502 should position itself relative to. This may comprise an OTP in accordance with embodiments described above. Alternatively, the data may comprise any form of information which enables the airborne vehicle 502 to confirm with a positioning beacon 504 that it is in an approximate intended location i.e. that it is positioning itself relative to the intended beacon 504.

The receiver 550 is communicably coupled with a data store 552. The data store 552 is configured to receive the landing identification data from the receiver 550 and retain this data in an appropriate format to be subsequently retrieved.

In some embodiments, the one or more positioning beacons 504 may be provided with a direct way of inputting the identification data via an input device 554. The beacons 504 are configured to store the data provided by the input device 554 in the data store 552. By way of example, the input device 554 may comprise a keypad, and the identification data may comprise a unique code, in accordance with embodiments described above.

In embodiments described above, the identification data which is provided both to the airborne vehicle 502 and the beacon 504 may be provided for a single instance of the airborne vehicle 502 conducting a positioning operation. In some embodiments of the present system, it may be desirable for the identification data for a particular beacon to be static, such that when an airborne vehicle 502 conducts repeat positioning operations with respect to the same beacon 504, the identification data is the same. In such embodiments, each of the one or more positioning beacons 504 may not be provided with the identification data either through direct input or via the external communications network 506, but instead this may comprise a static unique landing identifier for that particular beacon 504 which is intrinsic to the beacon 504 (e.g., a serial number for the beacon). In such embodiments, the landing identification data need not be provided to the beacon 504 for each use instance, however it will still be necessary to provide the landing identification data to the airborne vehicle 502 for each use instance. For example, prior to the airborne vehicle 502 embarking toward a positioning beacon 504 with a static unique landing identifier, the airborne vehicle 502 may be provided with the corresponding unique identifier in accordance with embodiments described above. At a later time, if the airborne vehicle 502 again embarks toward the same positioning beacon 504, it may again need to be provided with the corresponding unique identifier in order to enable the positioning to be carried out as designed.

The one or more positioning beacons 504 are further provided with one or more emitters or reflectors 556 to direct electromagnetic radiation toward the airborne vehicle 502. In accordance with embodiments described above, this electromagnetic radiation may be in the infrared spectrum. More specifically, the radiation may be Near Infra-Red (NIR). The one or more emitters or reflectors 556 are appropriately configured to direct the specific radiation toward the airborne vehicle 502. The one or more emitters or detectors 556 are configured to direct the electromagnetic radiation in a manner which enables a directionality of the radiation which is emitted or reflected to be ascertained by the airborne vehicle in accordance with embodiments described above. This directionality may enable the airborne vehicle 502 to precisely position itself with respect to the one or more positioning beacons 504. An example of an emitter 556 which may be used is an LED configured to emit the type of electromagnetic radiation designed to be detected by the airborne vehicle 502.

The number and arrangement of the one or more emitters or reflectors 556 may be adapted in order to enable the precise positioning of the airborne vehicle 502 with respect to the beacons 504 in accordance with embodiments described above. The positioning data which is provided to the airborne vehicle 502 (e.g. via the external communications network 506 as described above) is appropriately configured in accordance with the number and arrangement of the one or more emitters or reflectors 556. For example, in some examples, each of the beacons 504 may be provided with three emitters or reflectors 556 arranged in a distinct pattern (e.g., an L-shape). The positioning data provided to the airborne vehicle 502 (e.g. via the external communications network 506 as described above) may include an indication of this pattern, including the relative positions and distances of the emitters or reflectors 556 from one another. The positioning data may further indicate the apparent relative positions and distances of the emitters or reflectors 556 from one another when the airborne vehicle 502 is positioned in the correct precise location. The airborne vehicle 502 may then be manoeuvred to the correct precise location such that the radiation received from the emitters or reflectors 556 matches the positions in the positioning data. The use of three emitters or reflectors 556 enables precision positioning in embodiments where the intended location is static. In embodiments in which the intended location is moving (e.g., where the beacons 504 are on a moving vehicle), it may be necessary to include four or more emitters or reflectors 556. In some embodiments, fewer than three emitters or reflectors 556 may be utilised in addition to supplemental information provided to the airborne vehicle 502. This supplemental information may include information indicating where the emitters or reflectors 556 are to be placed relative to the intended position of the airborne vehicle 502. This supplemental information may further include information indicating an intended altitude for the airborne vehicle to be located relative to the emitters or reflectors 556. In some embodiments, the spacing between emitters or reflectors 556 may be standardised (namely be a predefined and known quantity for a plurality of beacons 504, such as a known geometric formation) for each of the beacons 504. In such cases, it may not be necessary to provide information relating to relative positions and distances between emitters or reflectors 556 to the airborne vehicle 502 as part of the positional data. Instead it may only be required to indicate how the airborne vehicle 502 should be positioned with respect to the emitted or reflected radiation.

The emitters 556 may also be provided with appropriate driver circuits to enable control of the emitters to achieve the functionality described herein.

The one or more positioning beacons 504 may further be provided with a transmitter 558 in order to provide an indication of the stored landing identification data to the airborne vehicle 502. The information provided from the transmitter 558 is configured to be in the same format as the unique identification data stored in the data store 512 of the airborne vehicle 502. In some embodiments, the one or more positioning beacons 504 provide the landing identification data from the transmitter 558 in a format configured to be received by the receiver 510 of the airborne vehicle 502. In other embodiments, the landing identification data is provided through appropriate communication between the one or more positioning beacons 504 and the airborne vehicle 502 via the external communication network 506. In yet other embodiments in which a transmitter 558 need not be provided, the landing identification data is provided from the one or more positioning beacons 504 through appropriately modulated electromagnetic radiation which is emitted from, or reflected by, the one or more positioning beacons 504 in accordance with embodiments described above. This may comprise one or more of the emitters 556 being configured to modulate the radiation being emitted such that it provides an indication of the landing identification data. In other embodiments in which reflectors 556 are used, the reflectors may be designed to embody a QR Code or Bar Code or other pattern that the airborne vehicle 502 is programmed to use to identify the landing identification data.

In some embodiments in which emitters are used, the emitters may be configured to be either passive (i.e., the emitter is always on and emitting radiation), or active (i.e., the emitter is configured to only emit radiation selectively). Typically, passive emitters will be used for the purposes of the airborne vehicle positioning itself relative to the beacons 504 and active emitters will be used both for this purpose and for transmitting landing identification data in accordance with the above embodiments. The active emitter may be configured to begin emission in accordance with a manual activation. Additionally or alternatively, the active emitter may be configured to begin emission during a time window in which an airborne vehicle is expected to be in the proximity of the beacon 504. This information may be provided in a manner analogous to the original provision of the location identification data. Further additionally, the active emitter may be configured to begin activation any time an airborne vehicle 502 is detected in the vicinity (regardless of whether it is intended to be positioned proximate to the relevant beacon). This may be achieved through use of suitably adapted proximity sensors included as part of the beacon 504 or by receiving a broadcast signal from the airborne vehicle.

The one or more positioning beacons 504 may further be provided with information indicating an approximate time in which the airborne vehicle 502 is expected to be proximate to the corresponding beacon 504. In such cases, the relevant beacon 504 may be configured to only transmit the identification data in accordance with the above embodiments during the indicated approximate time. This may advantageously enable the beacon 504 to save power by only transmitting at a time in which the airborne vehicle 502 is expected to be present.

In accordance with the above embodiments, the positioning beacon may also be provided with a processor 564. The processor 564 may be configured to conduct the operations of the positioning beacon 504 in accordance with the described embodiments. In particular, the processor may receive inputs from the receiver 550 and communicate with the data store 552. Similarly, the processor 564 may be configured to determine transmissions to be made, the timings of these transmissions and when the emitters 556 should be activated.

Both the airborne vehicle 502 and the beacons 504 may each be provided with a rechargeable battery 560, 562. The airborne vehicle 502 and the beacons 504 may be designed to be operated independently from a power supply and therefore may require a battery to operate. Where appropriate, the airborne vehicle 502 and the beacons 504 may be provided with means with which to recharge the battery e.g., solar panels, a connector to enable connection to a power supply etc.

In some cases, it may be beneficial for a plurality of beacons 504 to communicate with each other. This may be used to exchange relevant information efficiently, For instance, one beacon may receive a transmission from an airborne vehicle 502 passing proximate to it in accordance with some embodiments described above, and may notify other nearby beacons of the airborne vehicle 502. In cases where an active emitter is provided, this may provide an indication for the active emitter to begin emitting. In such instances, each of the beacons 504 may be configured to communicate with one another through use of provided receivers 550 and transmitters 558 via the external communication network 506. Whilst this one example has been provided, it is to be understood that the positioning beacons may be configured to communicate a variety of relevant information in order to assist the operation of the system. These may include, but are not limited to, the landing identification data and the positioning data. This may be useful in instances where longer distance communications channels are unreliable and passing information along a chain of positioning beacons 504 is more reliable than utilising the external communication network 506. In such embodiments, any data which is passed between beacons may be encrypted and configured to only be decrypted at the intended recipient beacon to which the data relates.

In the above examples, there may also be a centralised management system 570 provided (as shown in FIG. 7), which is configured to manage operation of the airborne vehicle 502 and the one or more positioning beacons 504 during a positioning operation. The centralised management system 570 may be configured to provide the unique identification data, landing identification data, the positional data and any other relevant information described in the above embodiments via the external communications network 506 (or otherwise). In particular, the centralised management system 570 may be operated by a user to input the required information for transmission to the airborne vehicle 502 and the one or more positioning beacons 504 in order to enable the functionality described above. To achieve this, the centralised management system 570 may be provided with one or more processors 572, memories 574, receivers 576 and transmitters 578 to enable this functionality. The centralised management system 570 may also be configured to receive the input from the user via one or more input devices.

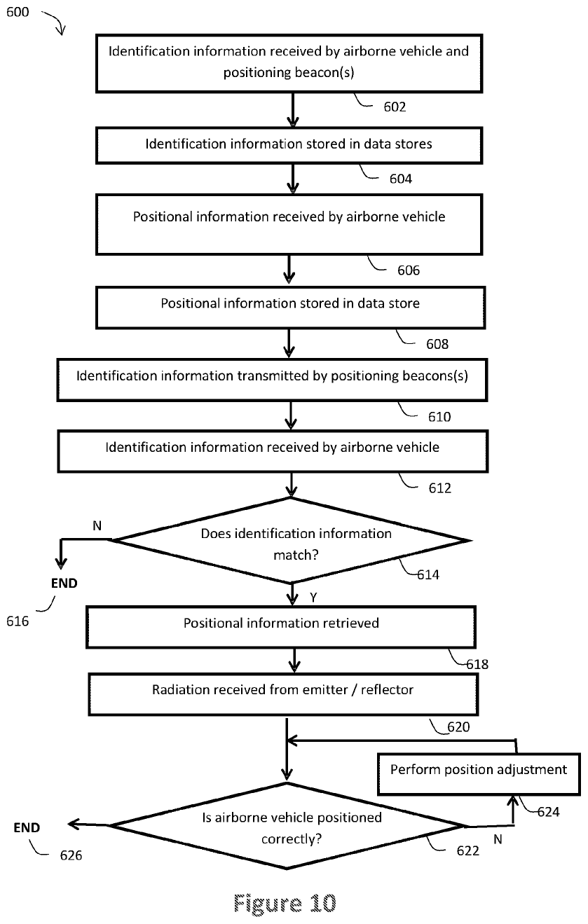

Referring now to FIG. 10, there is shown a method of operation 600 of the above general purpose system 500.

The method 600 proceeds by the airborne vehicle 502 and the one or more positioning beacons 504 receiving, at Step 602, the unique identification information and the landing identification respectively. This may be received via the external communications network 506 and may be received from a centralised management system 570. In some embodiments, the landing identification is already stored in the one or more positioning beacons 504. In such embodiments, this step may be skipped in respect of the positioning beacons 504 The respective identification information is then stored, at Step 604, in the data store 512 of the airborne vehicle 502 and the data store 552 of the one or more positioning beacons 504 (if it is not already stored there) respectively. Following this, the method proceeds by the airborne vehicle receiving, at Step 606, positional data in accordance with embodiments described above. In particular, this positional data provides information indicating how the airborne vehicle 502 should be positioned relative to the relevant positioning beacon 504. This positional data may be of the form of any of the embodiments described above. This positional data is subsequently stored, at Step 608, in the data store 512 of the airborne vehicle 502.

The method continues by the one or more positioning beacons 504 transmitting, at Step 610, the previously stored landing identification information. In accordance with embodiments described above, this may be performed continuously following receipt of the landing identification information, or on a restricted basis. This restricted basis may for example be during a time window that the airborne vehicle 502 is expected to be in the vicinity of the relevant beacon 504.

Following this, the airborne vehicle 502 receives, at Step 612, the landing identification data being transmitted by the one or more positioning beacons 504. It is to be appreciated that in some embodiments, the airborne vehicle 502 may first be configured to travel to an approximate location of the beacon it is intended to travel to. This may be achieved by the provision of GPS coordinates (or any other suitable means) which the airborne vehicle 502 is provided with. Once the transmitted identification data is received by the airborne vehicle 502, the airborne vehicle proceeds to compare, at Step 614, the received landing identification data with the unique identification data stored in the data store 512. If it is determined that the information data is not a match, the method proceeds to Step 616 where no further action is taken. In some embodiments, the airborne vehicle 502 may be configured to return to a predetermined point of origin. In further embodiments, the airborne vehicle 502 may be configured to adjust its position and await further identification data from an alternative beacon 504. This may be particularly useful in embodiments in which there are several beacons in a relatively small area (e.g. in urban environments).

Returning to Step 614, if it is determined that the identification data is a match, the method proceeds by the airborne vehicle 502 retrieving, at Step 618, the positional data from the data store 512. In some embodiments, the airborne vehicle 502 may be simply configured to move toward received radiation without requiring additional positional data. In such cases, steps relating to the use of receipt of positional data may be skipped. Following this retrieval, the airborne vehicle receives, at Step 620, radiation either emitted from, or reflected by the beacon 504 in accordance with embodiments described above. In embodiments in which the airborne vehicle 502 is configured to emit the radiation to be received, it may begin emission when the airborne vehicle 502 has matched the identification data as described above. Further, in embodiments in which the radiation is emitted from the beacon 504, the emission may be continuous, or may be configured to only emit at certain times e.g., during an expected time window that the airborne vehicle 502 is expected to be proximate to the beacon 504.

Following this, the airborne vehicle 502 determines, at Step 622, whether it is positioned correctly relative to the beacon 504 in accordance with the positional data. This is achieved by comparing the positional data to the radiation received in Step 620. This may be achieved through a pattern recognition algorithm. If it is determined that the airborne vehicle 502 is not appropriately positioned, the method proceeds to Step 624 where the airborne vehicle adjusts its position in accordance with the received radiation and the positional data. In particular, the airborne vehicle is configured to make algorithmic adjustments to its position to bring the airborne vehicle 502 in accordance with the required position per the positional data. Once these adjustments have been made, the method returns to Step 622 where the radiation received is again compared to the positional data. This process continues until it is determined that it is positioned correctly relative to the beacon 504 in accordance with the positional data (or in some embodiments, within a tolerable margin of error). Once this occurs, the method proceeds to end at Step 626.

It is to be appreciated that modifications to the above-described method may be implemented in accordance with other optional embodiments described herein.

Having described several exemplary embodiments of the present embodiments and the implementation of different functions of the device in detail, it is to be appreciated that the skilled addressee will readily be able to adapt the basic configuration of the system to carry out described functionality without requiring detailed explanation of how this would be achieved. Therefore, in the present specification, several functions of the system have been described in different places without an explanation of the required detailed implementation as this not necessary given the abilities of the skilled addressee to implement functionality into the system.

Furthermore, it will be understood that features, advantages, and functionality of the different embodiments described herein may be combined where context allows.

### REFERENCES

1. GPS Dependencies in the Transportation Sector DOT-VNT SC NOAA-16-01 US Department of Transportation
2. Robust Precision Landing for Autonomous Drones Combining Vision-based and Infrared Sensors Giannis Badakis et al 2021 IEEE Sensors Applications Symposium

1. A system for positioning an airborne vehicle at a geographic location, the system comprising:
the airborne vehicle having one or more infra-red (IR) detectors; and
a positioning beacon located at the geographic location, the positioning beacon being configured to wirelessly transmit a landing identifier for detection by the airborne vehicle and comprising one or more emitters or reflectors configured to respectively emit or reflect an IR signal;
wherein the airborne vehicle is configured to receive the landing identifier and the emitted or reflected IR signal to compare the received landing identifier and a stored unique identifier and if the received landing identifier matches the stored unique identifier to use the emitted or reflected signal to control movement of the airborne vehicle with respect to the positioning beacon.

2. The system of claim 1, wherein the movement of the airborne vehicle is controlled in accordance with stored positioning data comprising data indicating an intended position of the airborne vehicle relative to the IR radiation being emitted from or reflected by the one or more emitters or reflectors of the positioning beacon.

3. The system of claim 2, wherein the airborne vehicle further comprises a consignment holding system configured to enable the airborne vehicle to carry a load, and wherein the airborne vehicle is configured to operate the consignment holding system to accept or release a load when at the intended position.

4. The system of claim 1, wherein the airborne vehicle further comprises a GPS navigation system, and wherein the airborne vehicle is further configured to use stored GPS coordinates indicating an approximate position of the geographic location to control movement of the airborne vehicle toward the approximate position of the geographic location.

5. The system of claim 4, further comprising a second positioning beacon at a second geographic location, the second positioning beacon being configured to wirelessly transmit the landing identifier for detection by the airborne vehicle and comprising:
a second one or more emitters or reflectors configured to respectively emit or reflect an IR signal;
wherein the airborne vehicle is further configured to use stored GPS coordinates indicating an approximate position of the second geographic location to control movement of the airborne vehicle toward the approximate position of the second geographic location, and wherein the movement of the airborne vehicle is controlled in accordance with stored positioning data comprising data indicating a first and a second intended position of the airborne vehicle relative to the IR radiation being emitted from or reflected by the one or more emitters or reflectors of the positioning beacon and the second one or more emitters or reflectors of the positioning beacon respectively and the airborne vehicle further comprises:
a consignment holding system configured to enable the airborne vehicle to carry a load, and wherein the airborne vehicle is configured to operate the consignment holding system to accept a load when at the first intended position and to release the load at the second intended position.

6. The system of claim 1, wherein the one or more emitters or reflectors comprises one or more emitters, and the positioning beacon is further configured to transmit the landing identifier for detection by the airborne vehicle by appropriately modulating the IR radiation being emitted from at least one of the one or more emitters.

7. The system of claim 1, wherein the one or more emitters or reflectors comprises one or more emitters, the one or more IR detectors are configured to activate when at the geographic location, and the one or more emitters are configured to activate for a portion of the time that the one or more IR detectors are activated.

8. The system of claim 1, wherein the one or more emitters or reflectors comprises one or more reflectors, wherein at least one of the one or more reflectors comprises a QR code or a bar code or other pattern comprising the landing identifier, and transmission of the landing identifier comprises a reflected signal from the one or more reflectors received by the one or more IR detectors being recognised by the airborne vehicle.

9. The system of claim 8, wherein the airborne vehicle further comprises one or more emitters configured to direct IR radiation toward the one or more reflectors of the positioning beacon.

10. The system of claim 9, wherein the one or more emitters of the airborne vehicle are configured to activate when at the geographic location.

11. The system of claim 9, wherein the one or more IR detectors are configured to activate when at the geographic location, and the one or more emitters of the airborne vehicle are configured to activate for a portion of the time that the one or more IR detectors are activated.

12. The system of claim 1, wherein the one or more emitters or reflectors are configured to respectively emit or reflect near infra-red, NIR, radiation.

13. The system of claim 12, wherein the one or more emitters or reflectors are configured to respectively emit or reflect narrowband NIR.

14. The system of claim 1, wherein the airborne vehicle or the positioning beacon, comprises a receiver, and the airborne vehicle or the positioning beacon is configured to receive the unique identification data to be stored in a respective data store from an external communications network via the receiver.

15. The system of claim 1, wherein the airborne vehicle or the positioning beacon comprises a data input device, and the airborne vehicle or the positioning beacon is configured to receive the unique identification data to be stored in a respective data store from information input via the input device.

16. The system of claim 1, wherein the airborne vehicle is configured to land in a landing area, the location of the landing area being defined by the detected emitted or reflected signal.

17. The system of claim 16, wherein the positioning beacon comprises at least two emitters or reflectors, and the at least two emitters or reflectors are arranged with respect to one another and the landing area in a known geometric formation.

18. The system of claim 17, wherein the positioning beacon comprises three emitters or reflectors arranged in an L-shape.

19. The system of claim 17, wherein the positioning beacon comprises three or more emitters or reflectors and the positioning beacon is located on a moving surface.

20. The system of claim 1, wherein the one or more emitters or reflectors are configured to emit or reflect IR radiation substantially vertically.

21. The system of claim 1, wherein the positioning beacon comprises one or more emitters, and the one or more emitters are configured to emit IR radiation in accordance with an indicated time interval stored in the positioning beacon.

22. The system of claim 1, wherein the one or more IR detectors operate at a frequency of between 25 Hz and 200 Hz.

23. The system of claim 22, wherein the one or more IR detectors operate at a frequency of 60 Hz.

24. The system of claim 1, wherein the positioning beacon comprises a mobile telecommunications device, such as a smartphone.

25. The system of claim 1, wherein the one or more emitters or reflectors are configured to be attached to a mobile telecommunications device, such as a smartphone.

26. The system of claim 1, the positioning beacon further comprising a transmitter configured to transmit the landing identifier.

27. The system of claim 1, the airborne vehicle comprising at least one or more IR detectors, wherein the IR detectors are arranged with complementary fields of view, and the positioning beacon comprising at least four emitters or reflectors arranged in pairs, with at least one pair being arranged to emit or reflect IR signals in each of the complementary fields of view.

28. An airborne vehicle configured to be positioned at a geographic location, the airborne vehicle comprising:
one or more infra-red (IR) detectors for receiving an IR signal emitted or reflected from a positioning beacon provided at the geographic location;
wherein the airborne vehicle is configured to:
receive a landing identifier wirelessly transmitted to the airborne vehicle by the positioning beacon;
compare the received landing identifier and a stored unique identifier; and
if the received landing identifier matches the stored unique identifier, use the emitted or reflected signal to control movement of the airborne vehicle towards the positioning beacon.

29. A positioning beacon for positioning an airborne vehicle according to claim 28, the positioning beacon comprising:
one or more infra-red (IR) emitters or reflectors configured to respectively emit or reflect an IR signal for use in controlling movement of the airborne vehicle towards the positioning beacon; and
a generator for generating a signal including a landing identifier of the positioning beacon;
wherein the positioning beacon is configured to a wirelessly transmit the signal including the landing identifier for unique detection of the positioning beacon by the airborne vehicle.

30. A method for positioning an airborne vehicle at a geographic location, the method comprising:
wirelessly transmitting, from a positioning beacon at the geographic location, a landing identifier for detection by the airborne vehicle;
receiving an emitted or reflected infra-red, IR, signal from the positioning beacon at one or more IR detectors of the airborne vehicle;
receiving, at the airborne vehicle, the landing identifier;
comparing the landing identifier with a stored unique identifier; and
where the landing identifier and stored unique identifier match, use the emitter or reflected signal to control movement of the airborne vehicle with respect to the positioning beacon.

31. The method of claim 30, further comprising:
wirelessly transmitting, from a second positioning beacon at a second geographic location, the landing identifier for detection by the airborne vehicle;
controlling movement of the airborne vehicle using a GPS navigation system to move toward an approximate position of the geographic location using first stored GPS coordinates;
when at the approximate position of the geographic location, controlling movement of the airborne vehicle in accordance with stored positioning data comprising data indicating a first intended position of the airborne vehicle relative to the received IR radiation from the positioning beacon;
accepting a load into a consignment holding system of the airborne vehicle when at the first intended position;
once the load is accepted, controlling movement of the airborne vehicle using the GPS navigation system to move toward an approximate position of the second geographic location using second stored GPS coordinates;
when at the approximate position of the second geographic location, receiving an emitted or reflected IR signal from the second positioning beacon at the one or more IR detectors of the airborne vehicle;
controlling movement of the airborne vehicle in accordance with stored positioning data comprising data indicating a second intended position of the airborne vehicle relative to the IR radiation being emitted from or reflected by the second positioning beacon; and
releasing the load from the consignment holding system of the airborne vehicle when at the second intended position.
